(19) United States
(12) Patent Application Publication
(10) Pub. No.: US 2004/0111435 A1
(43) Pub. Date: Jun. 10, 2004

(54) System for selecting and creating composition formulations

(76) Inventors: Franz Herbert, Encinitas, CA (US); Christopher Michael Knox, San Marcos, CA (US); Grant Hulbert, San Marcos, CA (US); Jack Ladson, Yardley, PA (US); Jo Kirkenaer, Carlsbad, CA (US); Oliver UnterEcker, Kula, HI (US)

Correspondence Address: MCNAIR LAW FIRM, P.O. BOX 10827, GREENVILLE, SC, 29603-0827, US

(21) Appl. No.: 10/647,641

(22) Filed: Aug. 25, 2003

Related U.S. Application Data
(60) Provisional application No. 60/431,599, filed on Dec. 6, 2002.

(51) Int. Cl. G06F 7/00

(52) U.S. Cl. 707/104.1; 700/97

(57) ABSTRACT

This invention is directed to a system and method for selecting composition components or composition formulations for manufacturing plastics or other articles according to desirable selection criteria. This invention includes a computer readable medium containing a set of computer readable instructions and a components database where the set of computer readable instructions allows for receiving selection criteria, comparing the selection criteria with the database information, selecting composition components or composition formulations within a predetermined range of the selection criteria and displaying the selected components or formulations on a color correct monitor so that the user can view the search results without having to view actual physical samples.

### FIELD OF THE INVENTION

This invention is related to a system for selecting and correcting composition components and formulations according to desirable selection criteria such as color, appearance, and other physical properties and characteristics. Particularly, this invention is directed to a computerized system for searching a composition formulation database according to selection criteria to retrieve corresponding composition formulations from a predetermined inventory and to display the search results in a color correct manner to the user. Further, this invention is directed to a computerized system for creating composition formulations and adding them to a composition formulation database. This application claims priority on provisional patent application Serial No. 60/431,599, entitled System For Selecting Components Based Upon Colorimetry, filed Dec. 6, 2002.

### BACKGROUND OF THE INVENTION

In the manufacturing of many materials, specifically plastics such as polyethylene, ABS, and polypropylene, the properties of the product to be manufactured are important considerations when selecting composition components and formulations. Specifically, the color characteristics including color appearance and constancy, physical characteristics including hardness, chemical composition, acid resistance, flammability, stability, and UV resistance, and special effects, such as opacity, translucency and surface texture, are important properties for a customer to consider. A customer wishing to have a plastic product manufactured normally has a preconceived requirement that the product to be manufactured has a specific color. Unfortunately, color is a characteristic of a composition formulation that is difficult to describe without actually viewing the color appearance itself. Traditionally, when the customer requests a product to be a certain color, the customer is provided with physical samples, usually in the form of a plaque, of colored plastics that the manufacturer has in inventory. Unfortunately, these color samples can number in the hundreds and must be physically transmitted to the customer for review and selection. However, the customer's requirements for color and other characteristics may not match a particular formulation in the inventory of the manufacturer. Therefore, there are no physical samples to review. The customer is limited to only viewing physical samples that are “close.” It would be advantageous to have the ability to select composition components within a predetermined range of the customer's selection criteria or create new composition formulations, based upon the customer's requirements, from the contents of the composition components in inventory.

One of the more important characteristics of a product to be manufactured, especially from plastics, is color. Visible light, or “color”, occupies the wavelength interval of approximately 360 nanometers to 830 nanometers, sometimes abbreviated to a lesser range such as 400 to 700 nanometers. Since the wavelength sensitivity range of the human observer contains hundreds of discrete points, each with variable amplitude, several methods have been developed to describe color mathematically. For example, the notations for describing color space include RGB, CMYK, HSL, CIEXYZ, CIEYxy, CIEL*a*b*, CIEL*u*v* and CIEL*C*h. Generally, these notations provide a means for mapping color space that is commonly referred to as gamut mapping. It is within these color spaces that manufacturers compare existing colors in inventory with the color desired by the customer. The difference between the inventory color and the desired color of the customer is commonly referred to as Delta-E, a vector length in three dimensional color space such as, L*a*b*. One Delta-E maybe defined as an acceptable color difference. When comparing the spectral or tristimulus data of the color in inventory with a desired color, the closeness of a match can be determined objectively on a mathematical basis rather than relying upon individuals to perform visual comparisons with physical samples.

In injection molding, for example, the composition component containing colorants is generally added while the plastic is being formed. The challenge is then to determine the proper color components, referred to as the composition formulation, so that the finished product meets with the customer's selection criteria and requirements. Further, the properties and characteristics of the composition component used in the particular composition formulation are important. To illustrate this point, assume that several shades of red are sufficient for the customers color selection. However, one shade may be very expensive, one may not be in inventory, and one may not have the proper UV resistance or other desired characteristic.

As such, providing a system that allows for the selection of composition components and composition formulations while considering the desired properties of the final product, including color, is a problem that significant attention should be given.

To meet this need, it is an object of this invention to provide for a system for selecting composition components for composition formulations having a desirable color appearance for a product to be manufactured.

It is another object of this invention to provide a system for displaying selected composition components and color formulations without regard to physical location of the manufacturer or customer.

It is another object of this invention to provide a system for selecting a composition component that has properties and characteristics desirable to the customer for the requested manufactured product.

It is another object of this invention to provide for a system for selecting a manufacturing component having a desirable color and characteristics without having to provide a physical sample.

### SUMMARY OF THE INVENTION

The above objectives are achieved by providing a system and method for selecting composition components and creating composition formulations for a product to be manufactured according to a set of selection criteria comprising a computer readable medium, a composition component database embodied within the computer readable medium representing composition components used in composition formulations for manufacturing products having spectral and physical characteristics, a color display in communications with the computer readable medium, and, a set of computer readable instructions embodied in the computer readable medium for receiving selection criteria representing desirable color characteristics of a product to be manufactured, comparing the selection criteria with the spectral characteristics of the composition component database, selecting at least one composition component from the composition component database that has spectral characteristics within a predetermined range of the selection criteria, and displaying the at least one selected composition component to a user via the color display. The systems and methods also provide for calibrating the color display to enable the display to provide color corrected images, profiling the color display to enable the display to provide color corrected images, displaying the at least one selected composition component according to a first illuminant using a predetermining white point so as to be able to view the at least one selected composition component's color appearance in relation to the first illuminant, and altering the white point, thereby providing at second illuminant, and displaying the at least one selected composition component according to the second illuminant so that the at least one selected composition component's color appearance can be viewed under a plurality of light environments.

The system and method also provide for displaying the color appearance of the color characteristics of the selection criteria in proximity with the at least one composition component's color appearance so that a comparison between the selection criteria and the at least one composition component can be made, displaying the physical properties of the at least one composition component so that the associated physical properties of the at least one composition component are provided, and transmitting the at least one selected composition component information to a remote color calibrated display so that a remote user can view the at least one composition component.

The systems and methods also provide for a spectrometer in communication with the computer readable medium; and, computer readable instructions for receiving color characteristics of the selection criteria from the spectrometer, displaying the at least one selected composition component according to a first brightness using a predetermining white point so as to be able to view the at least one selected composition component's color appearance, displaying the at least one selected composition component surrounded by a predetermined background so as to minimize the effects of uncontrolled light when viewing the at least one composition component. The predetermined background can be a neutral color and the background can be modifying for color intensity.

The system and method also provide for a virtual surface to be provided representing the product to be manufactured embodied within the compute readable medium, instructions for coloring the virtual surface with a color represented by the at least one composition component so that the product to be manufactured can be viewed having a color appearance according to the at least one composition component, at least one special effect stored within the computer readable medium, and instructions for retrieving the at least one special effect and applying the at least one special effect to the virtual surface so that the product to be manufactured can be viewed according to color appearance and special effect.

### DESCRIPTION OF THE DRAWINGS

FIG. 1 is a schematic and flowchart showing the components and process for using the invention;

FIG. 2 is a flowchart illustrating the invention;

FIG. 3 is a flowchart illustrating the invention; and,

FIG. 4 is a schematic illustration the invention.

### DESCRIPTION OF A PREFERRED EMBODIMENT

The detailed description that follows may be presented in terms of program procedures executed on a computer or network of computers. These procedural descriptions are representations used by those skilled in the art to most effectively convey the substance of their work to others skilled in the art. These procedures herein described are generally a self-consistent sequence of steps leading to a desired result. These steps require physical manipulations of physical quantities such as electrical or magnetic signals capable of being stored, transferred, combined, compared, or otherwise manipulated readable medium that is designed to perform a specific task or tasks. Actual computer or executable code or computer readable code may not be contained within one file or one storage medium but may span several computers or storage mediums. The terms “host” and “server” may be hardware, software, or combination of hardware and software that provides the functionality described herein. This invention thereby allows multiple users, being geographically dispersed, to interact with data relating to physical characteristics of manufactured products using a system that ensures the precise and accurate conveyance of such information.

The present invention is described below with reference to flowchart illustrations of methods, apparatus (“systems”) and computer program products according to the invention. It will be understood that each block of a flowchart illustration can be implemented by a set of computer readable instructions or code. These computer readable instructions may be loaded onto a general purpose computer, special purpose computer, or other programmable data processing apparatus to produce a machine such that the instructions will execute on a computer or other data processing apparatus to create a means for implementing the functions specified in the flowchart block or blocks.

These computer readable instructions may also be stored in a computer readable medium that can direct a computer or other programmable data processing apparatus to function in a particular manner, such that the instructions stored in a computer readable medium produce an article of manufacture including instruction means that implement the functions specified in the flowchart block or blocks. Computer program instructions may also be loaded onto a computer or other programmable apparatus to produce a computer executed process such that the instructions are executed on the computer or other programmable apparatus providing steps for implementing the functions specified in the flowchart block or blocks. Accordingly, elements of the flowchart support combinations of means for performing the special functions, combination of steps for performing the specified functions and program instruction means for performing the specified functions. It will be understood that each block of the flowchart illustrations can be implemented by special purpose hardware based computer systems that perform the specified functions, or steps, or combinations of special purpose hardware or computer instructions. The present invention is now described more fully herein with reference to the drawings in which the preferred embodiment of the invention is shown. This invention may, however, be embodied in many different forms and should not be construed as limited to the embodiment set forth herein. Rather, these embodiments are provided so that this disclosure will be thorough and complete and will fully convey the scope of the invention to those skilled in the art.

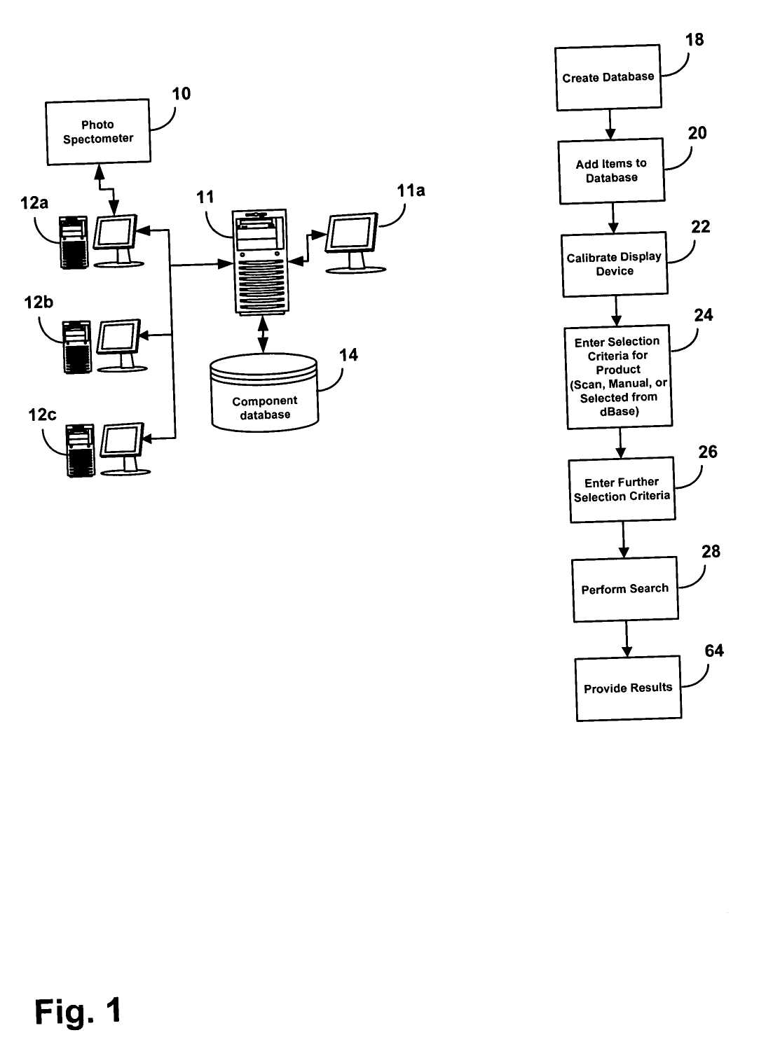

Referring now to FIG. 1, the invention is described in more detail. In order for the manufacturer to record its inventory of composition components, a composition components database 14 is created at step 18. This database can be embodied in the same computer readable medium 11 as the computer readable instructions described herein, or can be located in a separate server and in communications with the computer readable medium. Although many organizations of information can be used, a relational database is preferred and may include fields such as: record number, formulation, polymer type, resin, use rate, spectral reflectance or spectral transmittance, tristimulus data, optical density, opacity, contrast ratio, weatherability, FDA acceptability, manufacturing facility, production status, UV resistance, gloss, thermal stability, light stability, thickness, chemical resistance, hardness, weight, cost, etc.; each of which can be associated with composition components. Once database 14 is created, it is populated with values for composition components at step 20. Composition components can include color pigments added to plastic base material during the manufacture of a plastic product, pigment added to vehicle or other paints, colorant or dyes added to textiles, colorants added to inks, or colorants added to coatings, and any other color specific component that is used in the manufacture of products. As contained herein, a composition formulation is the combination of a plurality of composition components with any ratio of mixture. Composition formulations have the same characteristics, properties, and information as composition components, but gain these attributes from the combination of components. The color information associated with a composition component or formulation can be entered into the database by scanning, electronic transfer, measurement, or by manual entry. When scanning the composition component or formulation into the database, a spectrometer 10 can be used to gather the spectral or tristimulus data of the composition component or formulation. Spectral data is the quantifiable information that represents the reflectance and transmittance factor of color associated with that composition component or formulation. It should be noted that the database also has information associated with each composition component or formulation represented by the database such as: polymer class, product form, use rate, FDA status, thermal stability, light stability, plant location, opacity, percent colorant load, QC resin, special effect, antitoxidant, UV stability, color status, color number, and cost. These characteristics associated with the database information can also be used to query the database 14 to search for composition components or formulations that have desired characteristics and color.

As new composition components are added, edited or removed, database 14 can be updated to reflect these changes. In fact, since database 14 is accessible through multiple clients shown as 12a through 12c, the database can be constantly updated from many different physical locations as new manufacturing components are developed. This feature is advantageous so that a manufacturer with multiple locations can maintain the database as modifications to composition components are updated from different locations, and as new composition components are added to the database. Further, the database, when it also contains formulations, can be updated as new formulations are created from the composition components. A composition formulation is made from one or more composition components and contains its own characteristics, including color, made from the combination of composition components. Therefore, this invention also allows for the selection of composition formulations, having a plurality of composition components according to the user's selection criteria. For example, a customer may not desire an existing composition formulation in database 14 and the vendor can then create a new formulation by combining the existing composition components and provide the new formulation to the customer. The new formulation, with its attributes, can then be saved in database 14.

To manually enter an item into database 14, the color and product characteristics of the material can be entered directly from any client 12a through 12c. Manual entry of color values can take a number of forms, however, one embodiment uses independent on-screen slider controls for the component values of RGB or Hue, Saturation, and Lightness, for example. These values are used to represent a color component value that may be derived from the spectral reflectance or transmittance data values of the product created by a particular manufacturing formula. When these values are manually entered, the resulting stimulus can be displayed on a color display device in communications with the computer readable medium 11 that is in communication with database 14.

Since perceptual color can be greatly affected by the display used, it is advantageous to calibrate the display device as shown in step 22 so that precise color can be most accurately conveyed. The display devices can be calibrated in intensity, correlated color temperature, and response so that the same color appearance of the product to be manufactured is displayed and perceived by the viewer as if the product were located in the corresponding environment represented by the display device. The displays are calibrated for multiple illuminants such as: Daylight (D65) having a color temperature of 6500 degrees Kelvin; Fluorescent (F2) having a correlated color temperature of 4158 degrees Kelvin; and Horizon having a correlated color temperature of 2856 degrees Kelvin, so that color constancy is maintained when viewing the product to be manufactured. Although the illuminants cited herein are typical of those used in the industry, it is to be understood that this invention may use many other illuminants or illuminant combinations. Another component of the calibration procedure is the adjustment of the luminance or brightness level. The brightness level influences color perception so that observations made on multiple monitors must be adjusted to the same luminance level to provide consistent evaluations. Luminance levels of 200 candelas/m² on the display devices are preferred.

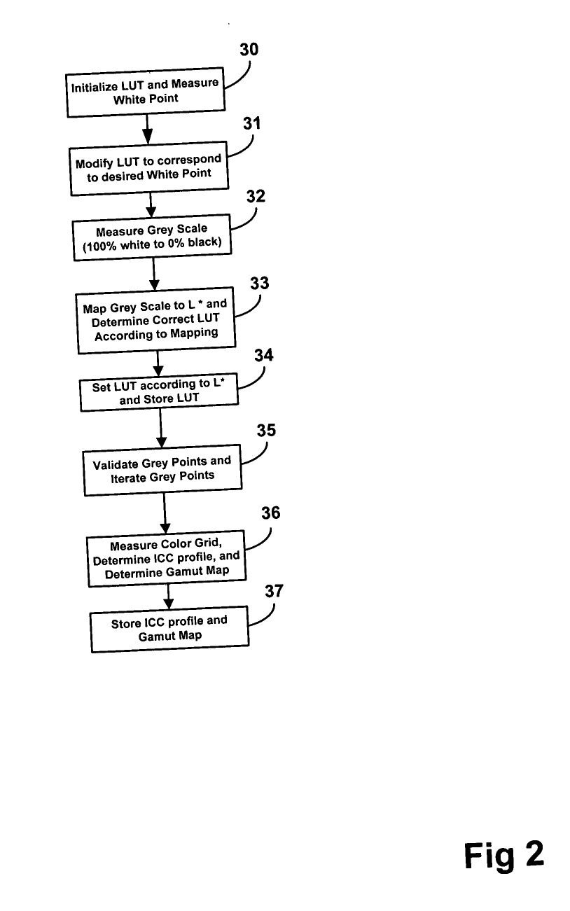

The calibration methodology is further explained in FIG. 2. Step 30 involves initializing the video Look-Up Table (LUT) to default values prior to measuring the white point. A LUT is a data structure that maps color indexes, or color space, to actual color values such as RGB. The “white point” is the whitest white of an illuminant that can be produced in a color space. For example, outdoors sunlight reflected off white generally serves as the white point for that illuminant. In a room at night, a single lamp's light reflected off white serves as the “white point” for that illuminant. Step 31 shows the step of modifying the LUT according to the white point measurements in the previous step. The end points of the LUT are modified using the white point as a scalar value so that the total color difference is less than 0.2 unit, DE*ab. The LUT is adjusted until the desired white point values are obtained from 100% white to 0% black. Step 32 measures a gray scale progressing incrementally from black at zero percent to white at full scale or one hundred percent white. At step 33, the invention maps the gray scale linearity against the lightness function, L*. Step 34 sets the LUTs according to the resultant values and stores the results. Step 35 increments the gray scale at intervals to validate the actual values. In step 36, the color grid is measured and the ICC profile is determined along with the gamut map. At step 37, the ICC profile and gamut map are stored. For efficiency, the preferred embodiment measures 33 gray steps between 100% white (full scale) and 0% black rather than the maximum potential points from 0 to 100 at step 32. In a typical video LUT, there are 256 points between 100% white and 0% black.

The values derived from the calibration procedures are stored in the LUT so that the input signal to the display device is modified to significantly reduce the error in display of the display device.

This invention, by including color profile information for each component of the invention, allows other software applications and other instruments associated with this invention to properly adjust the measurement, display, and viewing of spectral or tristimulus data values as a color stimulus so that the measured or displayed color is more accurately presented. The features and functions provided by the invention enables users to measure, store, and retrieve color data from a common source, view the color data and other related information, and transmit that data for viewing on other digital devices such as printers. This benefit provides “virtual” samples so that the selection of a color for manufacturing a product can be done without having to create a physical sample. By viewing the color characteristics of a prospective sample virtually, the customer or user can make appropriate design and manufacturing decisions without having to be presented with physical samples.

Once the composition components database has been populated with at least one component, the invention is prepared to receive customer selection criteria and to perform the search against the database accordingly. By way of example, a customer wishing to have manufactured a plastic container for a liquid cleaner will be used. The customer wishes for the plastic container to have a certain color. This desire of the customer is entered at step 24. It should be noted that the desired color of the customer can be received by the computer readable instructions embodied in the computer readable medium through scanning or manual entry. If the customer has not fully refined the desired color of the product that the customer wishes to have manufactured, the customer can be presented with selections of composition components, or formulations, from the database thereby allowing the customer to view possible options. Once the color is selected, step 26 provides for entering additional characteristics that can be included in the selection criteria for the search performed by the computer readable instructions.

Selection criteria may also relate to specifics concerning color selection such as standard color format, non-verified color, Pantone color, production lot, RAL color, or verified color standard. Selection criteria can include spectral characteristics and physical characteristics such as: antioxidant, antistat, UV resistance, FDA status; light stability; opacity; translucency; transparency; component location in inventory; special effects, including, additive, barrier, bubbles, camouflage, cork, fluorescent, fragrance, frost, glitter, granite, iridescent, laser mark, marble, metallic, pearlescent, phosphorescent, photochromic, soft touch, thermochromic, and wood grain; thermal stability including ranges such as 400-450f, 450-500f, 500-550f, 550-600f, <400f, and >600f; product form such as beads, flake, liquid, other, pellet, polypearl, powder, precolor, and salt and pepper; polymer class including, ABS, ABS/PC, acetal, acrylic, EVA, nylon, PET, polycarbonate, polyethylene, polypropylene, polyurethane, PPO, PVC—Flexible, PVC—Rigid, SAN, styrene—GPS, styrene—HIPS, styrene—MIPS, TPO, TPR, TPU, or wax; color difference; use rate; percent colorant load; QC Resin; or color number.

Once the selection criteria is received by the computer readable instructions, the selection criteria is compared with the characteristics of the composition components of the database to find a match within a predetermined range of the selection criteria at step 28. The range of the characteristic is specified by the appropriate manufacturer and part of the component specification. It should be noted that inventory information may be associated with each of the composition components in database 14, can be associated with the composition components through a separate database, or only exist as unassociated information. Therefore, inventory information can be used to inform customer as to the availability of the selected composition component.

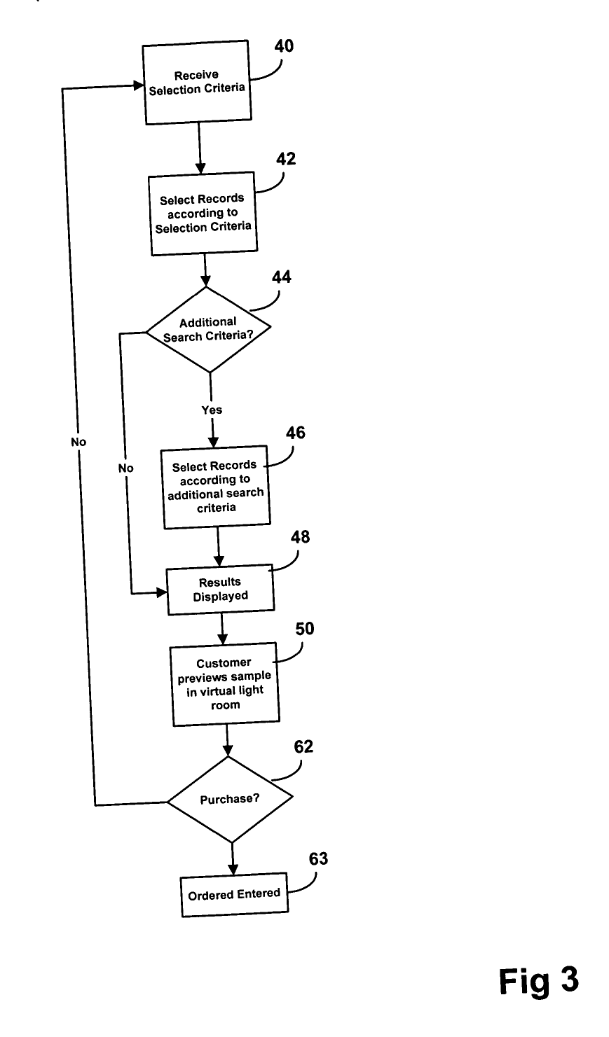

In performing the search, the set of computer readable instructions will first receive the selection criteria at step 40 of FIG. 3. The selection criteria is used to determine the records within composition components database 14 that are within the predetermined range of the color space relative to the data associated with the desired color of the customer at step 42. At step 44, the invention determines whether there are additional search criteria to be considered. If so, the selected list is further filtered according to the additional search criteria at step 46. The results are displayed at step 48.

The results can be shown at step 64 (FIG. 1) in a variety of formats such as color number, color values, color difference values, spectral data, pricing, cost, and product characteristics. The total color difference between the color of the selection criteria and that of the search results can be displayed so that a chart numerically defining the differences between the color of the selected composition component and the desired color is shown. The characteristics can be displayed that are associated with at least one composition component selected. The customer can then preview anticipated composition components in a customer appropriate environment at step 50. The decision to purchase is made at step 62 and an order can be entered at step 63 thereby effecting the inventory count of the selected composition components.

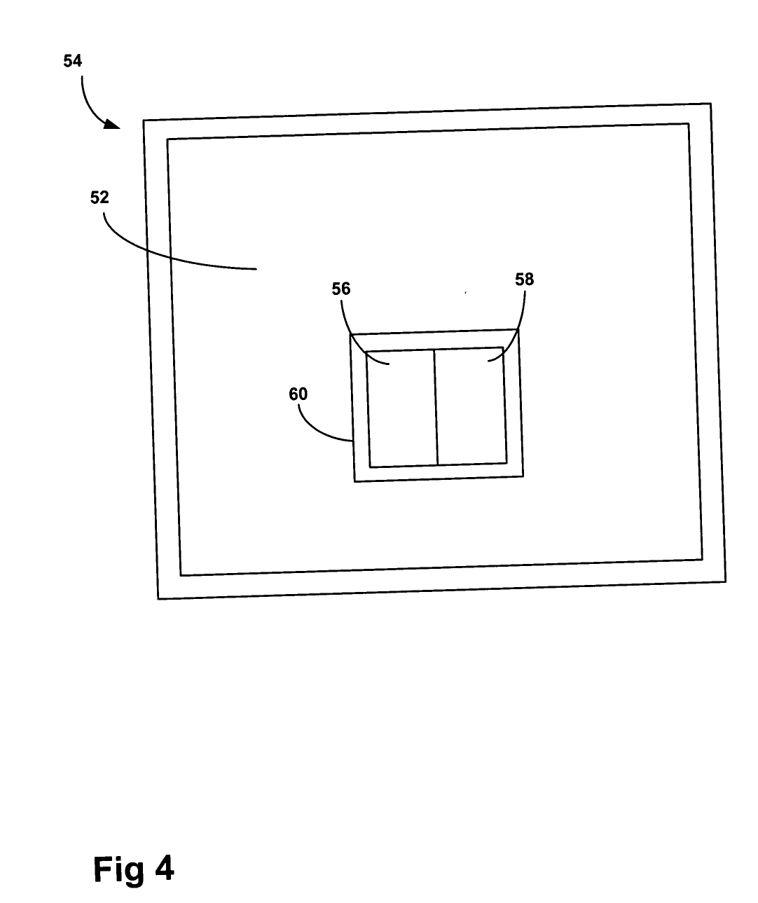

In one embodiment of this invention, a virtual light box 54 (FIG. 4) is displayed on a calibrated display device to allow the customer to view the product under different lighting conditions. This feature allows for the customer to determine if the product will appear as the proper color in certain lighting conditions. The virtual light box provides a neutral surround 52 to minimize the effect of uncontrolled light. Further, the virtual light box provides a specified and controlled source of illumination with variable intensity. When individuals view color, the environment surrounding the color product influences perception of color. A specific “white point” appropriate for the illuminant is provided in the field of view to use as a frame of reference for proper chromatic adaptation of the observer. This invention allows for colors to be displayed relative to an appropriate white point associated with their ultimate environment. For example, Tide® orange may be viewed under the illuminant used in a store's fluorescent lighting, while an automobile paint color can be viewed under sunlight. This invention allows the manipulation of the “white point” by calibration and profiling the display device for the appropriate illuminant. A surround, shown as 52 of FIG. 4, can be displayed to resemble a traditional light box shown generally as 54. The color requested by the customer is shown as 56 and can be compared to one of the results of the search 58 for a side-by-side comparison. A border 60 of variable size and intensity, called the proximal field, can be added around the displayed color representations, or other locations in the field of view of the observer, to further provide a white point to allow for chromatic adaptation.

When viewing the color of a selected composition component, the computer readable instructions allow a customer to view a representation of the selected color, embodied on a two or three-dimensional virtual object. The customer may select to view an object having textures and other special effects features such as granite, translucency, transparency, pearls, metallics, fluorescents, iridescent, and marble. The special effects can be applied in varying degrees to produce varying effects. The customer may view a simulation of the selected color and special effect, embodied on the selected virtual object, in the virtual light box or other virtual environment to provide lighting conditions appropriate for the product's end use. To assist the customer, a computer generated graphical object representing the configuration of the product can be created for the customer. Once such method for creating an object is by measuring the bidirectional reflectance functions (BDRF) associated with the product to be virtually created. The BDRF is created according to wavelength and is determined by the structural and optical properties of the surface, such as shadow-casting, multiple scattering, mutual shadowing, transmission, reflection, absorption and emission by surface elements, facet orientation distribution and facet density. Once the virtual model is created, the color, as well as the special effects, is applied to the virtual representation of the object so that the customer can see the color appearance of the selected composition components that could be used to manufacture the product. The computer instructions also allow for the selection and application of various special effects such as pearlescence, marble, granite, iridescence, metallic, surface texture, gloss, thickness, transparency, and translucency.

When retrieving color selection information, the computer readable instructions allow for storing and retrieving color information based upon color name, color number, color data tristimulus values, and spectral reflectance or transmittance values. Specifically, the computer instructions allow for the selecting of a color from the composition components database using a standard computer color pallet similar to that integrated into Microsoft Windows or Macintosh platforms. The computer instructions also allow for the selection of color to be performed in the observer mode and under the selected illuminant that provides for viewing the retrieved or measured color on the screen. Sorting colors based upon color characteristics or color criteria that are returned during a search can also be preformed. Of course, color data values can be displayed with a variety of data formats.

The invention provides a variety of data output formats such as printing file data and exporting that data to computer readable files. The user may print data associated with the various user interface by selecting from a variety of formats to print the data. The data may also be written to an electronic file for use outside the system by other computer applications.

The numerous details set forth herein are provided to facilitate the understanding of the invention and are not provided to limit the scope of the invention. Accordingly, the disclosure of embodiments of the invention is intended to be illustrative of the scope of the invention and is not intended to be limiting. It is intended that the scope of the invention shall be limited only to the extent required by the appended claims.

What is claimed is:

1. A system for selecting composition components for a composition formulation for a product to be manufactured according to a set of selection criteria comprising:
a computer readable medium;
a composition component database in communication with said computer readable medium representing composition components used in composition formulations for manufacturing products having color characteristics;
a color display in communications with said computer readable medium; and,
a set of computer readable instructions embodied in said computer readable medium for receiving selection criteria representing desirable color characteristics of a product to be manufactured, comparing said selection criteria with said color characteristics of said composition component database, selecting at least one composition component from said composition component database that has color characteristics within a predetermined range of said selection criteria, and displaying said at least one selected composition component to a user via said color display.

2. The systems of claim 1 wherein said set of computer readable instructions include instructions for calibrating said color display to enable said display to provide color correct images.

3. The system of claim 1 wherein said set of computer readable instructions include instructions for profiling said color display to enable said display to provide color correct images.

4. The systems of claim 1 wherein said computer readable instructions include instructions for displaying said at least one selected composition component according to a first illuminant using a predetermining white point and brightness level so as to be able to view said at least one selected composition component's color appearance in relation to said first illuminant.

5. The system of claim 4 wherein said computer readable instructions include instructions for altering said white point or said brightness level, thereby providing at second illuminant, and displaying said at least one selected composition component according to said second illuminant so that said at least one selected composition component's color appearance can be viewed under a plurality of light environments.

6. The system of claim 1 wherein said computer readable instructions include instructions for displaying a color appearance associated with said selection criteria in proximity with said at least one composition component so that a comparison between said selection criteria and said at least one composition component can be made.

7. The system of claim 1 wherein said computer readable instructions include instructions for displaying said physical properties of said at least one composition component so that the associated characteristics of said at least one composition component are provided.

8. The system of claim 1 wherein said computer readable instructions include instructions for transmitting said at least one selected composition component information to a remote color calibrated display so that a remote user can view said at least one composition component.

9. The system of claim 1 wherein said computer readable instructions include instructions for displaying said at least one selected composition component in a neutral background under a predetermined white point and brightness level so as to be able to view said at least one selected composition component's color appearance.

10. The system of claim 1 wherein said computer readable instructions include instructions for displaying said at least one selected composition component in a proximal field surrounded by a predetermined neutral background so as to minimize the effects of adaptation when viewing said at least one composition component.

11. The system of claim 1 including:
a virtual surface representing said product to be manufactured embodied within said compute readable medium; and,
said computer readable instructions include instructions for applying a color to said virtual surface with a color represented by said at least one composition component so that said product to be manufactured can be viewed having a color appearance according to said at least one composition component.

12. The system of claim 11 including:
at least one special effect stored within said computer readable medium; and,
said computer readable instructions include instructions for retrieving said at least one special effect and applying said at least one special effect to said virtual surface so that said product to be manufactured can be viewed according to color appearance and special effect.

13. The system of claim 1 including:
a composition formulation database in communication with said computer readable medium; and,
said set of computer readable instructions include instructions for creating a composition formulation according to a plurality of composition components and storing said composition formulation in said composition formulation database.

14. A system for selecting composition formulations for a product to be manufactured according to a set of selection criteria comprising:
a computer readable medium;
a composition formulation database in communication with said computer readable medium representing formulations having at least once composition component for manufacturing products having desirable color characteristics;
a color display in communication with said computer readable medium; and,
a set of computer readable instructions embodied in said computer readable medium for receiving selection criteria representing desirable properties of a composition formulation for a product to be manufactured, comparing said selection criteria with said color characteristics of said composition formulation database, selecting at least one composition formulation from said composition formulation database having color characteristics within a predetermined range of said selection criteria, and displaying said at least one selected composition formulation to a user via said color display.

15. The systems of claim 14 wherein said set of computer readable instructions include instructions for calibrating said color display device to enable said color display device to provide color correct images.

16. The system of claim 14 wherein said set of computer readable instructions include instructions for profiling said color display device to enable said display device to provide color correct images.

17. The systems of claim 14 wherein said computer readable instructions include instructions for displaying said at least one selected composition formulations according to a first illuminant using a predetermining white point and brightness level so as to be able to view said at least one selected composition formulation's color appearance in relation to said first illuminant.

18. The system of claim 17 wherein said computer readable instructions include instructions for altering said white point or brightness level, thereby providing a second illuminant, and displaying said at least one selected composition formulation according to said second illuminant so that said at least one selected composition formulation's color appearance can be viewed under a plurality of light environments.

19. The system of claim 14 wherein said computer readable instructions include instructions for displaying said selection criteria in proximity with said at least one composition component so that a comparison of the color appearance between said selection criteria and said at least one composition formulation can be made.

20. The system of claim 14 wherein said computer readable instructions include instructions for displaying said physical properties of said at least one composition formulation so that the associated characteristics of said at least one composition formulation are provided.

21. The system of claim 14 wherein said computer readable instructions include instructions for transmitting said at least one selected composition formulation information to a remote color calibrated display so that a remote user can view said at least one composition formulation.

22. The system of claim 14 wherein said computer readable instructions include instructions for displaying said at least one selected composition formulation in a neutral background according to a predetermined white point and brightness level so as to be able to view said at least one selected composition formulation's color appearance.

23. The system of claim 14 wherein said computer readable instructions include instructions for displaying said at least one selected composition formulation in the proximal field surrounded by a predetermined neutral background so as to minimize the effects of adaptation when viewing said at least one composition formulation.

24. The system of claim 14 including:
a virtual surface representing said product to be manufactured embodied within said compute readable medium; and,
said computer readable instructions include instructions for applying a color to said virtual surface with a color represented by said at least one composition formulation so that said product to be manufactured can be viewed having a color appearance according to said at least one composition formulation.

25. The system of claim 24 including:
at least one special effect stored within said computer readable medium; and,
said computer readable instructions include instructions for retrieving said at least one special effect and applying said at least one special effect to said virtual surface so that said product to be manufactured can be viewed according to color appearance and special effect.

26. A method for selecting a composition component for inclusion in a composition formulation for a product to be manufactured according to a set of selection criteria comprising the steps of:
providing a set of composition components representing composition components used in composition formulations for manufacturing products having color characteristics;
receiving said selection criteria representing desirable color characteristics of a product to be manufactured;
selecting at least one composition component from said set of composition components having color characteristics within a predetermined range of said selection criteria; and,
displaying said at least one selected composition component for viewing on a color corrected display.

27. The method of claim 26 including the step of calibrating said display so that said display is color correct.

28. The method of claim 26 including the step of profiling said display so that said display is color correct.

29. The method of claim 26 including the step of displaying said at least one composition component using a first illuminant using a predetermined white point and brightness level so as to be able to view said at least one selected composition component's color appearance in relation to said first illuminant.

30. The method of claim 29 including the steps of:
altering said white point, thereby providing a second illuminant; and,
displaying said at least one selected composition component according to said second illuminant so that said at least one selected composition component's color appearance can be viewed under a plurality of light environments.

31. The method of claim 29 including the steps of:
altering said brightness level, thereby providing a second illuminant; and,
displaying said at least one selected composition component according to said second illuminant so that said at least one selected composition component's color appearance can be viewed under a plurality of light environments.

32. The method of claim 26 including the step of displaying the color appearance of said color characteristics of said selection criteria in proximity with said at least one composition component's color appearance so that a color appearance comparison between said selection criteria and said at least one composition component can be made.

33. The method of claim 26 including the step of displaying said physical properties of said at least one composition component so that the associated physical properties of said at least one composition component are provided.

34. The method of claim 26 including the step of transmitting said at least one selected composition component information to a remote color calibrated display so that a remote user can view said at least one composition component.

35. The method of claim 26 including the steps of displaying said at least one selected composition component according to a first brightness using a predetermining white point so as to be able to view said at least one selected composition component's color appearance.

36. The method of claim 26 including the steps of displaying said at least one selected composition component surrounded by a predetermined background so as to minimize the effects of adaptation when viewing said at least one composition component.

37. The method of claim 26 including the steps of:
providing a virtual surface representing said product to be manufactured; and,
applying color to said virtual surface with a color represented by said at least one composition component so that said product to be manufactured can be viewed having a color appearance according to said at least one composition component.

38. The method of claim 37 including the steps of:
providing at least one special effect stored within said computer readable medium; and,
applying said at least one special effect to said virtual surface so that said product to be manufactured can be viewed according to color appearance and special effect.

39. The method of claim 26 including the steps of:
determining a composition formulation according to at least one composition component; and,
storing said composition formulation in a computer readable medium.

40. A method for selecting a composition formulation for a product to be manufactured according to a set of selection criteria comprising the steps of:
providing a set of composition formulations representing composition formulations used for manufacturing products having color characteristics;
receiving said selection criteria representing desirable color characteristics of a product to be manufactured;
selecting at least one formulation from said set of composition formulations having color characteristics within a predetermined range of said selection criteria; and,
displaying said at least one selected composition formulation for viewing on a color corrected display.

41. The method of claim 40 including the step of calibrating said display so that said display is color correct.

42. The method of claim 40 including the step of profiling said display so that said display is color correct.

43. The method of claim 40 including the step of displaying said at least one composition formulation using a first illuminant using a predetermined white point and brightness level so as to be able to view said at least one selected composition formulation's color appearance in relation to said first illuminant.

44. The method of claim 43 including the steps of:
altering said white point, thereby providing at second illuminant; and,
displaying said at least one selected composition formulation according to said second illuminant so that said at least one selected composition formulation's color appearance can be viewed under a plurality of light environments.

45. The method of claim 40 including the step of displaying the color appearance of said color characteristics of said selection criteria in proximity with said at least one composition formulation's color appearance so that a color appearance comparison between said selection criteria and said at least one composition formulation can be made.

46. The method of claim 40 including the step of transmitting said at least one selected composition formulation information to a remote color calibrated display so that a remote user can view said at least one composition formulation.

47. The method of claim 40 including the steps of displaying said at least one selected composition formulation according to a first brightness using a predetermining white point so as to be able to view said at least one selected composition formulation's color appearance.

48. The method of claim 40 including the steps of displaying said at least one selected composition formulation surrounded by a predetermined background so as to minimize the effects of adaptation when viewing said at least one composition formulation.

49. The method of claim 40 including the steps of:
providing a virtual surface representing said product to be manufactured; and,
applying color to said virtual surface with a color represented by said at least one composition formulation so that said product to be manufactured can be viewed having a color appearance according to said at least one composition formulation.

50. The method of claim 49 including the steps of:
providing at least one special effect stored within said computer readable medium; and,
applying said at least one special effect to said virtual surface so that said product to be manufactured can be viewed according to color appearance and special effect.
